(19) United States
(12) Patent Application Publication
(10) Pub. No.: US 2008/0135610 A1
(43) Pub. Date: Jun. 12, 2008

(54) METHOD OF RECOGNIZING CHARACTERS ON CHECK IN AUTOMATED CHECK PROCESSING MACHINE

(75) Inventor: In Gyu Roh, Anyang-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nautilus Hyosung, Inc., Seoul (KR)

(21) Appl. No.: 11/952,386

(22) Filed: Dec. 7, 2007

(30) Foreign Application Priority Data
Dec. 8, 2006 (KR) 10-2006-124941
Dec. 8, 2006 (KR) 10-2006-124942

(51) Int. Cl. G06Q 40/00; G06Q 90/00

(52) U.S. Cl. 235/379

(57) ABSTRACT

The present invention relates to a magnetic ink character recognition (MICR) for a check in an automated check processing machine, and more particularly, to a method of recognizing characters on a check in an automated check processing machine, in which only an MICR reading unit repeatedly reads magnetic ink characters several times or an MICR reading unit together with a scanner read magnetic ink characters on a check, then compares the magnetic ink characters, and corrects error codes, so that probability of MICR read error is reduced and a recognition rate of the check is enhanced.

### CROSS-REFERENCE TO RELATED APPLICATIONS

The present invention claims priority of Korean patent application number 10-2006-124941, filed on Dec. 8, 2006 and Korean patent application number 10-2006-124942, filed on Dec. 8, 2006, which are incorporated by reference in its entirety.

### BACKGROUND OF THE INVENTION

The present invention relates to a magnetic ink character recognition (MICR) for a check in an automated check processing machine, and more particularly, to a method of recognizing characters on a check in an automated check processing machine, in which only an MICR reading unit repeatedly reads magnetic ink characters several times or an MICR reading unit together with a scanner read magnetic ink characters on a check, then compares the magnetic ink characters, and corrects error codes, so that probability of MICR read error is reduced and a recognition rate of the check is enhanced.

In relation to banking services, an automated teller machine (ATM) is an automated apparatus that can support fundamental financial services, such as deposit or withdrawal of money, regardless of space and time without a teller. The automated teller machine is configured to allows a user to handle the machine to process a transaction for automatically depositing or withdrawing cashes (bills) using a medium, such as a card or passbook. The automated teller machine can be extendedly operated after business hours of a branch of a bank or can be installed in a department store, a supermarket, or the like to be operated unmanned, and thus, the number of the automated teller machines is expected to be increased in the future. In this background, efficiency of the automated teller machine appears as an important issue among financial institutes such as banks, together with efficiency and rationalization of personnel.

In the meantime, the automated teller machine is generally provided with a cash receive-and-dispense unit for receiving and dispensing cashes, and recently, the automated teller machine tends to be provided with a check receive-and-dispense unit for freely depositing or withdrawing checks, i.e., securities.

FIG. 1 is a sectional view showing a process of transferring a check in an automated teller machine, and FIG. 2 is a view showing a surface of an MICR check.

A schematic process of transferring a deposited check will be described with reference to FIGS. 1 and 2. The automated teller machine is provided with a separate check receive-and-dispense unit 110 for processing a check, in addition to a bill receive-and-dispense unit. That is, a check input into the check receive-and-dispense unit 110 is transferred along a transfer route by feeding rollers, and a reader of an MICR reading unit 120 determines whether the check is valid or reads magnetic ink characters of the check. If the check is invalid, the check returns to the check receive-and-dispense unit 110 through a return path 130. If the check is successfully processed, a stamp is printed on the check and the check is stored in a stacking unit 150.

The MICR reading unit 120 reads magnetic signals coming out from the magnetic ink characters printed on the check and converts the magnetic signals into electrical signals. However, if a magnetic ink character field 210 of the check is not properly contacted with the MICR reading unit 120, the magnetic signals read by the MICR reading unit are weak, and thus, the check cannot be correctly read.

In addition, drive motors for operating the feeding rollers should be driven at a desired constant speed according to a control signal of a controller so that a plurality of rollers and gears are driven at a proper timing to smoothly read the magnetic ink characters of the check. However, although a constant drive voltage is applied from a motor driving circuit to motors, driving speeds of a plurality of motors are different from each other depending on their own characteristics or states, and thus drive timing errors occur between the rollers meshed with each other. Therefore, although the magnetic ink character field 210 of the check is properly contacted with the MICR reading unit 120, the check cannot be correctly read. Furthermore, although a conventional MICR reading unit has an excellent recognition rate, the damage rate of character recognition is so high that a check is not properly read and frequently returned if an image of the check is not extracted.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method is provided for recognizing characters on a check in an automated check processing machine in which only an MICR reading unit repeatedly reads magnetic ink characters several times or an MICR reading unit together with a scanner read magnetic ink characters on a check, then compares the magnetic ink characters, and corrects error codes, so that probability of MICR read error is reduced and a recognition rate of the check is enhanced.

According to an aspect of the present invention for achieving the objects, there is provided a method of recognizing characters on a check comprising a first step for extracting MICs of a check and partitioning the MICs into characteristic regions, by an MICR reading unit, if the check is input through the check receive-and-dispense unit. The method includes a second step for converting codes of the characteristic regions into certain bit values and a third step for temporarily storing the converted code data, re-extracting the MICs of the check for a predetermined number of times. if an error code occurs while performing the code conversion, the codes are converted into certain bit values. The method further includes a fourth step for comparing the stored code data with newly converted code data, correcting the error code, and configuring a serial number.

In addition, the present invention provides a method of recognizing characters on a check comprising a first step for extracting MICs of a check and partitioning the MICs into characteristic regions, by an MICR reading unit, if the check is input through the check receive-and-dispense unit and a second step for converting codes of the characteristic regions into certain bit values. The method further comprises a third step for temporarily storing the converted code data, requesting image data from the scanning unit, and receiving the image data, if an error code occurs while performing the code conversion. The method yet further comprises a fourth step for converting codes of the image data, comparing the temporarily stored code data with the converted code data of the image data, correcting the error code, and configuring a serial number.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a sectional view showing a process of transferring a check in an automated teller machine;

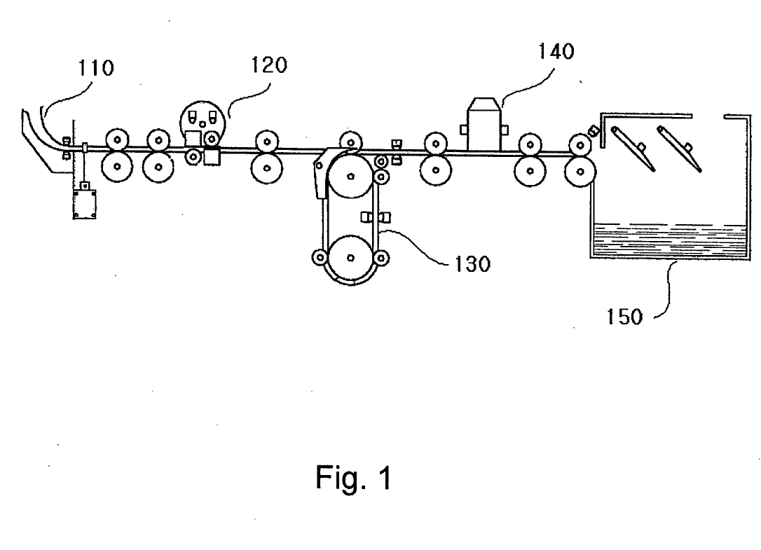

FIG. 2 is a view showing a surface of an MICR check;

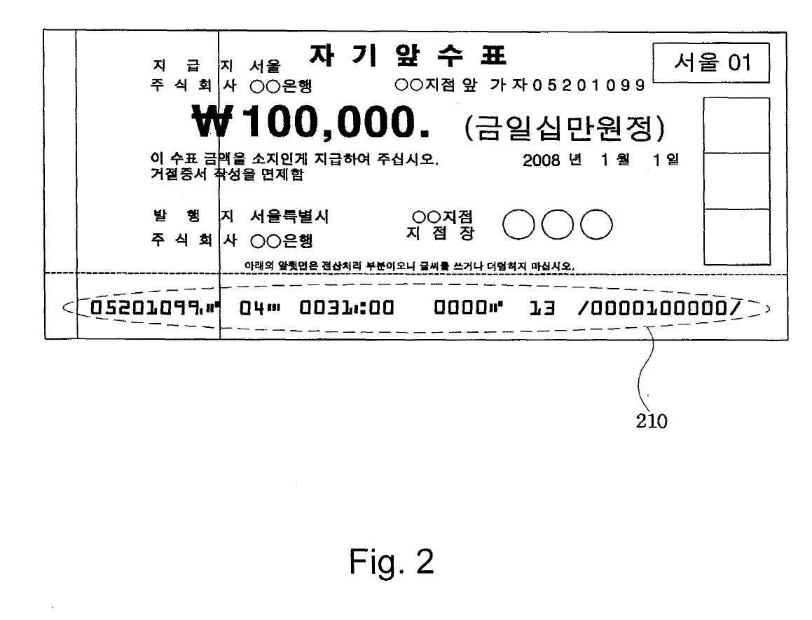

FIG. 3 is a view showing an automated check processing machine according to an embodiment of the present invention;

FIG. 4 is a flowchart illustrating a method of recognizing characters on a check according to a first embodiment of the present invention; and

FIG. 5 is a flowchart illustrating a method of recognizing characters on a check according to a second embodiment of the present invention.

### DESCRIPTION OF THE PREFERRED EMBODIMENT

Hereinafter, embodiments of the present invention will be described in detail with reference to the accompanying drawings.

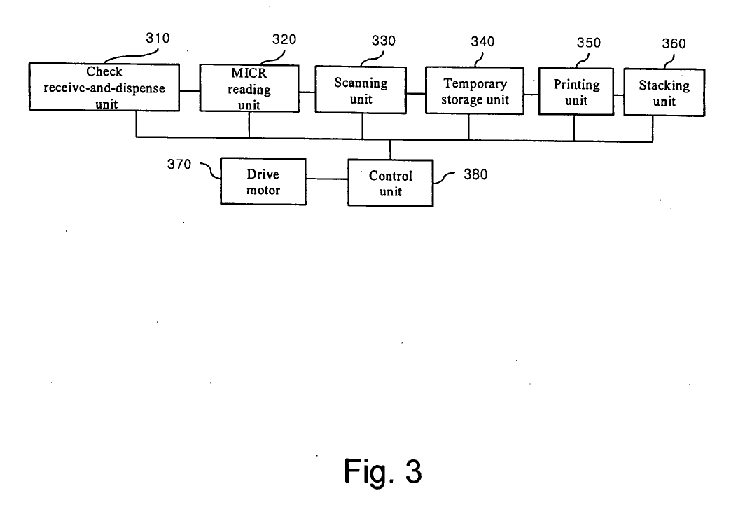

FIG. 3 is a view showing an automated check processing machine according to an embodiment of the present invention.

As shown in FIG. 3, the automated check processing machine of an unmanned automated machine according to the embodiment of the present invention comprises a check receive-and-dispense unit 310, an MICR reading unit 320, a scanning unit 330, a temporary storage unit 340, a printing unit 350, a stacking unit 360, a drive motor 370, and a control unit 380.

The check receive-and-dispense unit 310 comprises a check receive-and-dispense sensor, a shutter, a shutter solenoid, and feeding rollers, for inputting a check to be deposited or dispensing a check to be withdrawn. The check receive-and-dispense sensor is an optical sensor including a light emitting sensor and a light receiving sensor in a pair and senses a check if the check is taken in or taken out. Such an optical sensor is well-known and thus will not be described in detail. All sensors described below perform the same function as the check receive-and-dispense sensor. The shutter solenoid receives a signal from the check receive-and-dispense sensor to control the shutter, and the feeding rollers transfer the check to the MICR reading unit 320, which will be described later.

The MICR reading unit 320 extracts an image of a check number recorded in magnetic ink characters (MICs) on the surface of a deposited or withdrawn check, partitions the image into characteristic regions, recognizes the serial number of the check using the partitioned characteristic regions, and transmits the recognized check serial number to the control unit 380.

The MICR reading unit 320 includes a contact roller and a sensor, and the image recognized by the MICR reading unit 320 is transferred to the control unit 380 through a communication means (not shown) in the automated check processing machine. Here, the communication means may include a small computer system interface (SCSI), a universal serial bus (USB), or the like. The contact roller is in close contact with the check image to make the background of the check image noticeable, and the sensor may sense whether two or more checks are input at a time.

The scanning unit 330 is to scan the surface of the check, and the scanned image data are compressed, transferred to the control unit 380, and transmitted to a financial institute server. In the embodiment, a contact image sensor (CIS) is employed as a scanner, and a scanning operation is performed while the check is in close contact with the reading surface.

In addition, if the MICR reading unit 320 does not normally read the MICs, the scanning unit 330 of the present invention transfers the image data scanned by the scanning unit 330 to the MICR reading unit 320 to extract an image of the check number. A conventional scanning unit scans the surface of a check and immediately transmits the scanned image to the financial institute server, but the scanning unit 330 of the present invention transmits the scanned image data to the financial institute sever and at the same time transits the image data to the MICR reading unit 320 when the MICR reading unit requests. The scanning unit 330 has a low image recognition rate and a low damage rate, so that the scanning unit is very useful as a subsidiary apparatus for the MICR reading unit 320 that has a high image recognition rate and a high damage rate.

The temporary storage unit 340 is a place for keeping a check before a deposited check is finally transferred to the stacking unit 360 described below or before a withdrawn check is discharged to the check receive-and-dispense unit 310. The temporary storage unit 340 is to cope with a case where a user who desired to deposit or withdraw a check cancels deposit or withdrawal of the check.

The printing unit 350 prints an endorsement of an account number or a card number of a deposit customer on the surface of the deposited check, or an issuance date on the surface of a withdrawn check.

The stacking unit 360 stacks checks to be withdrawn and discharges the stacked checks, and checks passing through the temporary storage unit 340 are stacked in the stacking unit when an amount corresponding to the checks is deposited.

The drive motor 370 rotates clockwise or counterclockwise according to a control command and functions as a driving unit for rotating rollers of respective parts coupled with one another by timing belts and transferring checks. The transfer mechanism related to the coupling relations between the drive motor 370 and the rollers and the associative relations with the sensors are well known in the prior art and thus will not be described in detail.

The control unit 380 controls the respective constitutional parts and communicates with the financial institute server to confirm whether the check is a normally issued check using the serial number of the check transferred from the MICR reading unit 320.

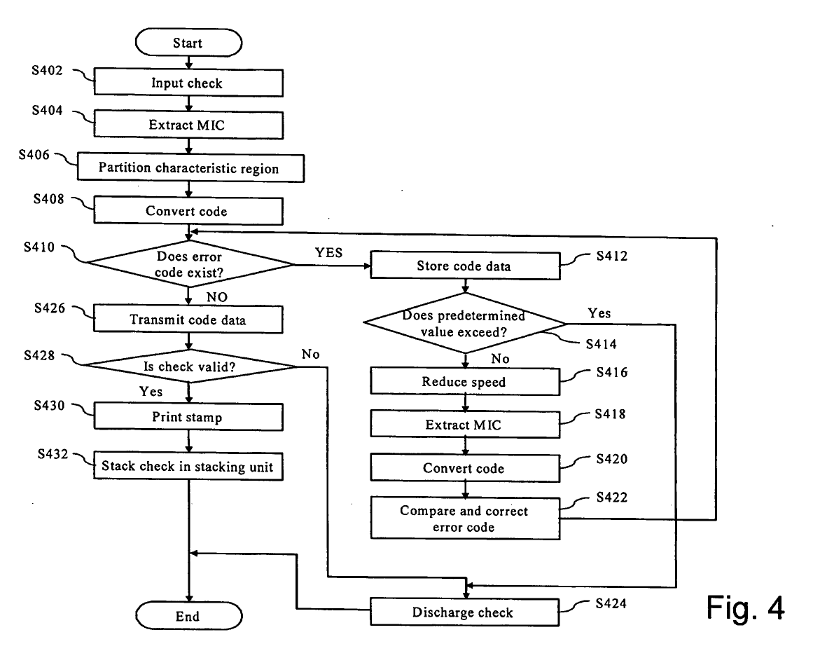

FIG. 4 is a flowchart illustrating a method of recognizing characters on a check according to a first embodiment of the present invention.

First, if a user deposits a check, i.e., a security, through the check receive-and-dispense unit (step S402), the check is transferred to the MICR reading unit by the feeding rollers. The MICR reading unit extracts an image of the check number recorded in MICs on the surface of the check (step S404) and partitions the image into characteristic regions (step S406). Next, the MICR reading unit converts the codes in the partitioned regions into certain bit values (step S408).

If a region has an error code that is not converted when the codes are converted (step S410), the converted code data are temporarily stored (step S412). Then, the MICs of the check are extracted again, and the codes are converted into certain bit values.

At this time, if the number of extracting the MICs of the check exceeds a predetermined number (step S414), the check is determined as an invalid check and discharged through the check receive-and-dispense unit (step 424). However, if the extraction number does not exceed the predetermined number, the drive motor rotates in the reverse direction to transfer the check before the MICR reading unit to extract an image of the check number again.

In addition, if the image of the check number is extracted again, the control unit reduces the rotational speed of the drive motor to a certain level lower than the currently set speed (step S416), and thus, the MICR reading unit reads the image of the check number further more slowly. Further, in order to reduce processing time, an image is extracted only from the region having an error code (step S418), and the code is converted (step S420).

If the image of the check is extracted again, the previously stored code data are compared with the re-extracted code data, and the error code is corrected to configure a serial number (step S422). For example, if the code data read and converted in the first stage is 05201099 04 00321 0□□3 000100000 (□□is an error code) and code data read and converted only for an error region in the second stage is 0013, the two code data are compared with each other, and the error code is corrected to configure an integrated serial number of the check of 05201099 04 00321 0013 000100000. If the integrated serial number of the check does not have an error any more, the control unit controls the drive motor to store the check in the temporary storage unit, and the MICR reading unit transfers the integrated serial number of the check to the control unit (step S426).

The control unit communicates with the financial institute server using the communication means installed in the automated check processing machine and transmits the serial number of the check to confirm whether the check is a validly issued check (step S428). If the check has been validly issued as a result of the confirmation, the check is transferred to the printing unit, and a card number or an account number of the check deposit user is printed on the surface of the check (step S430). Thereafter, the check is transferred along the transfer route thereby being stacked in the stacking unit (step S432).

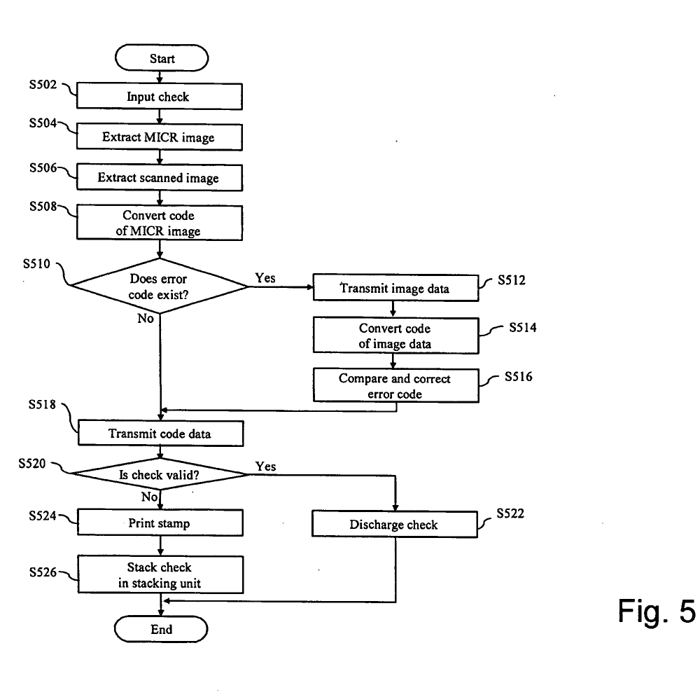

FIG. 5 is a flowchart illustrating a method of recognizing characters on a check according to a second embodiment of the present invention.

First, if a user deposits a check, i.e., a security, through the check receive-and-dispense unit (step S502), the check is transferred to the MICR reading unit by the feeding rollers. The MICR reading unit extracts an image of the check number recorded in MICs on the surface of the check (step S504) and partitions the image into characteristic regions. In the meantime, the control unit scans the check image transferred from the MICR reading unit using the scanning unit (step S506), and causes the check to stand by in the temporary storage unit.

Next, the MICR reading unit converts the codes in the partitioned regions into certain bit values (step S508). If there is a region having an error code that is not converted when the codes are converted (step S510), the converted code data are temporarily stored. Then, the MICR reading unit receives the image data scanned by the scanning unit (step S512) and converts codes of the image data into certain bit values (step S514).

If the image data received from the scanning unit are code converted, the previously stored code data is compared with the converted code data of the image data, and the error code is corrected (step S516). For example, if the code data read and converted in the first stage is 05201099 04 00321 0□□3 000100000 (□□is an error code) and the code data converted from the image data received from the scanning unit in the second stage is 0□□01099 04 0□□21 0013 0001□□□00, the two code data are compared with each other, and the error code is corrected to configure an integrated serial number of the check of 05201099 04 00321 0013 000100000. At this moment of correction, the code data read and converted by the MICR reading unit has the priority.

Thereafter, the MICR reading unit transfers the integrated serial number of the check to the control unit (step S518). The control unit communicates with the financial institute server using the communication means in the check receive-and-dispense machine and transmits the serial number of the check to confirm whether the check is a validly issued check (step S520). If the check is invalid as a result of the confirmation, the check returns again through the check receive-and-dispense unit (step S522). If the check is valid, the check is transferred to the printing unit, and a card number or an account number of the check deposit user is printed on the surface of the check (step S524). Then, the check is transferred along the transfer route to be stacked in the stacking unit (step S526).

Although the specific embodiments, such as an automated check processing machine, have been described herein, various modifications can be made thereto without departing from the scope of the present invention. Therefore, it will be apparent that the scope of the invention is not defined by the aforementioned embodiments but includes the appended claims and their equivalents.

What is claimed is:

1. A method of recognizing characters on a check in an automated check processing machine which includes a check receive-and-dispense unit for receiving and dispensing a check, an MICR reading unit for reading MICs of the check, a printing unit for printing a stamp on a surface of a normally processed check, a stacking unit for keeping the check, and a control unit for controlling the units of the automated check processing machine, the method comprising:
a first step for extracting the MICs of the check and partitioning the MICs into characteristic regions, by the MICR reading unit, if the check is input through the check receive-and-dispense unit;
a second step for converting codes of the characteristic regions into certain bit values;
a third step for temporarily storing the converted code data, re-extracting the MICs of the check for a predetermined number of times, and converting the codes into certain bit values, if an error code occurs while performing the code conversion; and
a fourth step for comparing the stored code data with newly converted code data, correcting the error code, and configuring a serial number.

2. The method as claimed in claim 1, wherein if the number of performing the third step exceeds a predetermined number, the check is determined as an invalid check and discharged to the check receive-and-dispense unit.

3. The method as claimed in claim 1, wherein in the third step, each time the MICs of the check are re-extracted, a speed of reading the MICs is reduced to a certain level.

4. The method as claimed in claim 1, wherein in the third step, when the MICs of the check are re-extracted, only MICs of a characteristic region having the error code are re-extracted.

5. A method of recognizing characters on a check in an automated check processing machine which includes a check receive-and-dispense unit for receiving and dispensing a check, an MICR reading unit for reading MICs of the check, a scanning unit for image processing and recognizing the check, a printing unit for printing a stamp on a surface of a normally processed check, a stacking unit for keeping the check, and a control unit for controlling the above parts, the method comprising:
a first step for extracting the MICs of the check and partitioning the MICs into characteristic regions, by the MICR reading unit, if the check is input through the check receive-and-dispense unit;
a second step for converting codes of the characteristic regions into certain bit values;
a third step for temporarily storing the converted code data, requesting image data from the scanning unit, and receiving the image data, if an error code occurs while performing the code conversion; and
a fourth step for converting codes of the image data, comparing the temporarily stored code data with the converted code data of the image data, correcting the error code, and configuring a serial number.

6. The method as claimed in claim 5, wherein in the fourth step, when the temporarily stored code data are compared with the converted code data of the image data and the error code is corrected, the temporarily stored code data has a priority.

7. The method as claimed in claim 1, further comprising a fifth step of confirming whether the check is valid by transmitting the serial number of the check to the control unit, if the serial number is configured.
